(19) United States
(12) Patent Application Publication
(10) Pub. No.: US 2025/0146358 A1
(43) Pub. Date: May 8, 2025

(54) Extendable Mounting Apparatus for Blinds and Shades

(71) Applicant: Eduardo Gomes de Araujo, Langley (CA)

(72) Inventor: Eduardo Gomes de Araujo, Langley (CA)

(21) Appl. No.: 18/937,012

(22) Filed: Nov. 4, 2024

Related U.S. Application Data
(60) Provisional application No. 63/595,681, filed on Nov. 2, 2023.

(51) Int. Cl. E06B 9/44; E06B 9/24; E06B 9/40

(52) U.S. Cl. CPC E06B 9/44; E06B 2009/2452; E06B 2009/405; E06B 2009/407

(57) ABSTRACT

An extendable mounting apparatus for a window covering allows blinds or shades to be mounted into a window or door frame of any width. The apparatus includes a mountable headrail, a proximal telescopic rod, a distal telescopic rod, a proximal window covering, and a distal window covering. The mountable headrail is mounted into a window or door frame by adjusting a length of the mountable headrail to be equal to a width of the window or door frame. The proximal telescopic rod and the distal telescopic rod lengthen or shorten in unison with the mountable headrail. The proximal telescopic rod is used to hang the proximal window covering. The distal telescopic rod is used to hang the distal window covering. The proximal telescopic rod and the distal telescopic rod are positioned in such a way that the proximal window covering and the distal window covering overlap each other.

The current application claims a priority to the U.S. provisional patent application Ser. No. 63/595,681 filed on Nov. 2, 2024. The current application is filed on Nov. 4, 2024, while Nov. 2, 2024 was on a weekend.

### FIELD OF THE INVENTION

The present invention generally relates to an extendable mounting apparatus for window/door blinds and shades. More specifically, the present invention is an extendable mounting assembly with dual rods and shades that transpose each other leaving no gaps for luminosity in the center and permitting the width of the whole assembly, including the headrail to be adjusted to the window or door frame's dimension by sliding in and out.

### BACKGROUND OF THE INVENTION

If we look around, we will see windows in every home or business and to control luminosity it needs to be covered. Furthermore, windows are a great focal point in a room and blinds and shades should be both decorative and functional. However, finding the right blinds for your needs is not always a quick open-and-shut deal. Further, finding rods and blinds/curtains/shades that fit the exact dimensions of your windows or doors is often a task. Most of the time, professional consultation is taken that requires a technical visit to take measurements and to calculate a reduced dimension to leave a slack on the headrail length to be fabricated that would allow the piece to be installed. Furthermore, to find the right type of blinds that would work with the measurements or any small mistake in the calculation from the professional consultant or any change in the exact dimension during manufacturing would put this blind/shade in a situation of being too small and leaving gaps on each side of the window that should be covered or being too big that would not fit the window/door frame. Also, when two curtains or blinds lie adjacent one after the other with a single rod, inevitably creates a gap between them which permits luminosity to enter through that gap. Thus, an extendable mounting apparatus for windows and/or door blinds with shades that would fit a range of widths, avoid the necessity of technical consultation for precise measures, leave no gaps for luminosity in the center, and save space on transportation and storage is a rare find to the current market. Both rods can work together synchronized to each other or each rod can operate independently.

An objective of the present invention is to provide users with a mounting apparatus for window and/or door shades that provides a large range of width adjustment for a perfect fit within its range, so users can take rough measures and the mounting apparatus will be adapted during installation simply sliding in and out. The present invention can be mounted on the ceiling, including ceiling recess, along with blind pockets or any window or door frames in a concealed fashion for a seamless and unobtrusive solution. Further, the apparatus is compatible with different kinds and shapes and materials of shades, such as roller blinds, pleated curtains, etc. Furthermore, the present invention is compatible with any opening and closing system including manual or motorized. Additionally, the present invention reduces storage, transportation, and store space as the product can be packed at a smaller width and will cover up to a larger width for each size.

### SUMMARY OF THE INVENTION

The present invention is intended to provide users with a mounting apparatus for window and/or door shades that provides a large range of width adjustment for a perfect fit within a range, so users can take rough measures and the mounting apparatus will be adapted during installation simply sliding in and out. To accomplish this, the present invention comprises an independent dual rail/rod system with shades, that transpose each other leaving no gaps for luminosity in the center as well as permitting the width to be adjusted to the window or door frame's dimension by sliding in and out. More specifically, the present invention comprises a plurality of telescopic axes with two blind rolls/panels overlapping each other. The present invention may be mounted on the ceiling, including ceiling recess, along blind pockets or along any window or door frames in a concealed fashion for a seamless and unobtrusive solution. Further, the apparatus is compatible with different kinds of shades, such as roller blinds, pleated curtains, etc. Furthermore, the present invention is compatible with any opening and closing system including manual or motorized. Additionally, the present invention reduces storage, transportation, and store space as the product can be packed at a smaller width and will cover up to a larger width for each size as well as eliminate the necessity of a technical consultation for precise width measurements.

### BRIEF DESCRIPTION OF THE DRAWINGS

FIG. 1 is a top-front-left perspective view of the present invention.

FIG. 2 is a bottom-rear-left perspective view of the present invention.

FIG. 3 is an exploded bottom-front-right perspective view of the present invention, wherein a plurality of mounting brackets that connect the present invention to an external wall or surface is shown.

FIG. 4 is a front-elevational view of the present invention.

FIG. 5 is a cross-sectional view of the present invention taken along line A-A′ in FIG. 4.

FIG. 6 is a detailed view taken about circle 6 in FIG. 5.

FIG. 7 is an exploded rear elevational view of the present invention.

FIG. 8 is a right-side elevational view of the present invention.

FIG. 9 is a top-plan view of the present invention.

FIG. 10 is a bottom plan view of the present invention.

FIG. 11 is a front elevational view of the present invention, wherein the panel box and the curtain rods are in an extended configuration.

FIG. 12 is a front elevational view of the present invention, wherein the panel box and the curtain rods are in a retracted configuration.

FIG. 13 is a schematic view illustrating one embodiment of the present invention.

FIG. 14 is a schematic view illustrating another embodiment of the present invention.

### DETAILED DESCRIPTION OF THE INVENTION

All illustrations of the drawings are for the purpose of describing selected versions of the present invention and are not intended to limit the scope of the present invention.

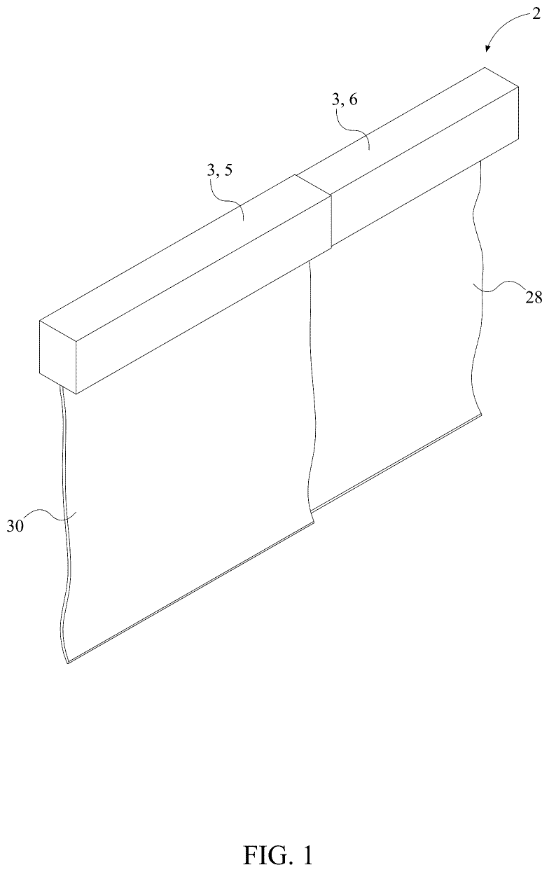

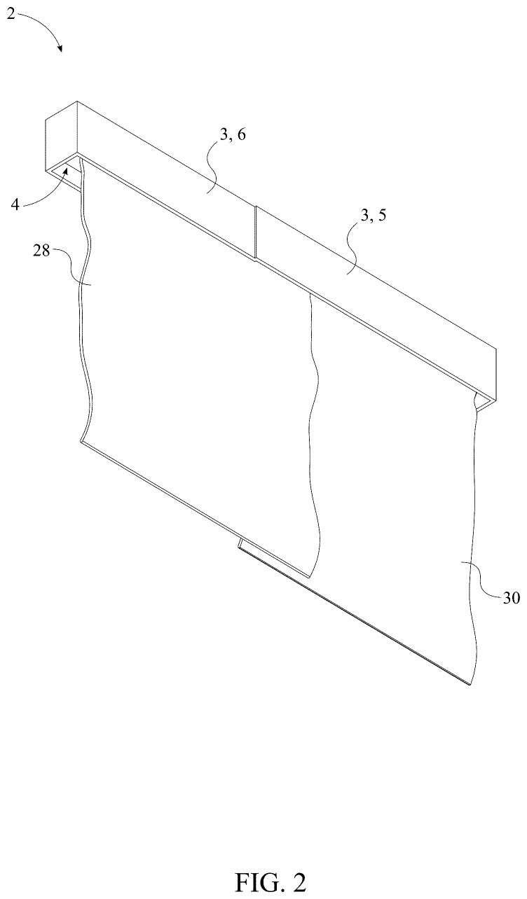

The present invention is an extendable mounting apparatus for a window covering that is used to mount blinds or shades into a window or door frame of any width because the present invention itself is adjustable to any width. Thus, the present invention comprises a mountable headrail 2, a proximal telescopic rod 8, a distal telescopic rod 18, a proximal window covering 28, and a distal window covering 30, which is shown in FIGS. 1 and 2. The mountable headrail 2 is an elongated structural base that allows the present invention to be physically mounted within a window or door frame. The mountable headrail 2 comprises a telescopic rail body 3 and an elongated cavity 4. The telescopic rail body 3 allows the mountable headrail 2 to be length-adjustable and comprises a first body portion 5 and a second body portion 6, which move in relation to each other in order to increase or decrease an overall length of the mountable headrail 2. The elongated cavity 4 is used to house and connect the other components of the present invention. The proximal telescopic rod 8 is an elongated length-adjustable member that is located closer to a window or a door, while the distal telescopic rod 18 is another elongated length-adjustable member that is located farther away from the window or the door. In addition, the proximal telescopic rod 8 is used to mount the proximal window covering 28 into the mountable headrail 2, while the distal telescopic rod 18 is used to mount the distal window covering 30 into the mountable headrail 2. Moreover, the proximal telescopic rod 8 comprises a first proximal rod end 10 and a second proximal rod end 12, and the distal telescopic rod 18 comprises a first distal rod end 20 and a second distal rod end 22, all of which are reference components of the present invention to better define the connections between functional components of the present invention.

The general configuration of the aforementioned components allows the present invention to efficiently and effectively mount a covering (e.g., blinds, shades, etc.) into a window or door frame. The first body portion 5 and the second body portion 6 are slidably connected to each other, which allows the mountable headrail 2 to be telescopic. As one example, the first body portion 5 and the second body portion 6 can be slid apart from each other to accommodate a wider window or door frame. As another example, the first body portion 5 and the second body portion 6 can be slid towards each other to accommodate a narrower window or door frame. The elongated cavity 4 laterally traversing into the telescopic rail body 3 so that the proximal window covering 28 and the distal window covering 30 are able to laterally extend out of the mountable headrail 2 and are able to cover their respective portions of a window or door frame. Thus, the proximal telescopic rod 8 and the distal telescopic rod 18 need to be positioned within the elongated cavity 4 and need to be positioned parallel and offset to each other, which allows the proximal window covering 28 to be hung from the proximal telescopic rod 8 and allows the distal window covering 30 to be hung from the distal telescopic rod 18. In addition, the first proximal rod end 10 and the first distal rod end 20 are connected within the first body portion 5, and the second proximal rod end 12 and the second distal rod end 22 are connected within the second body portion 6, which secures the proximal telescopic rod 8 and the distal telescopic rod 18 within the mountable headrail 2. This arrangement between the mountable headrail 2, the proximal telescopic rod 8, and the distal telescopic rod 18 allows the proximal telescopic rod 8 and the distal telescopic rod 18 to be lengthened as the mountable headrail 2 is lengthened by a user and allows the proximal telescopic rod 8 and the distal telescopic rod 18 to be shortened as the mountable headrail 2 is shortened by the user. Moreover, the proximal window covering 28 and the distal window covering 30 need to traverse into the elongated cavity 4 in order to respectively connect to the proximal telescopic rod 8 and the distal telescopic rod 18. The proximal window covering 28 and the distal window covering 30 also overlap each other so that the proximal window covering 28 and the distal window covering 30 do not mechanically interfere with each other as the present invention is lengthened or shortened by a user.

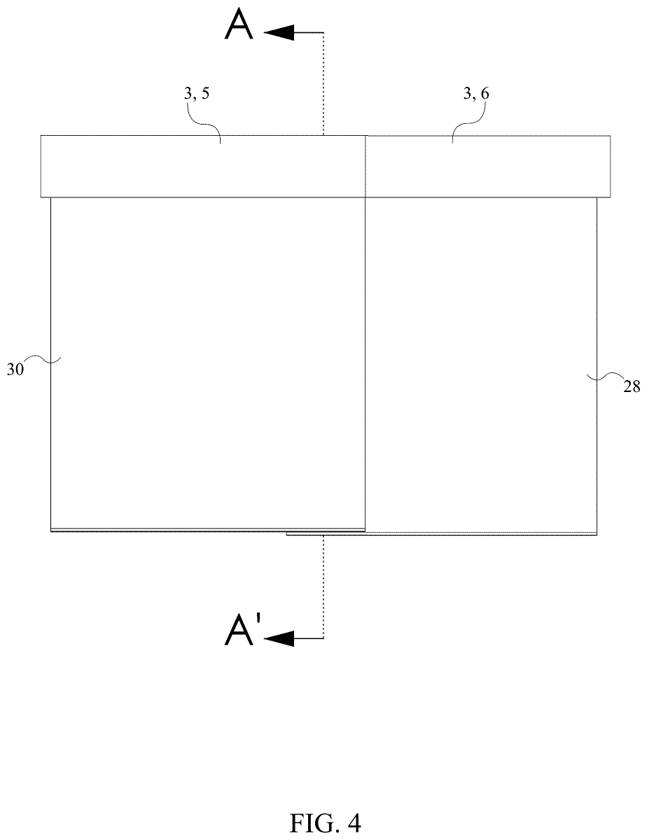

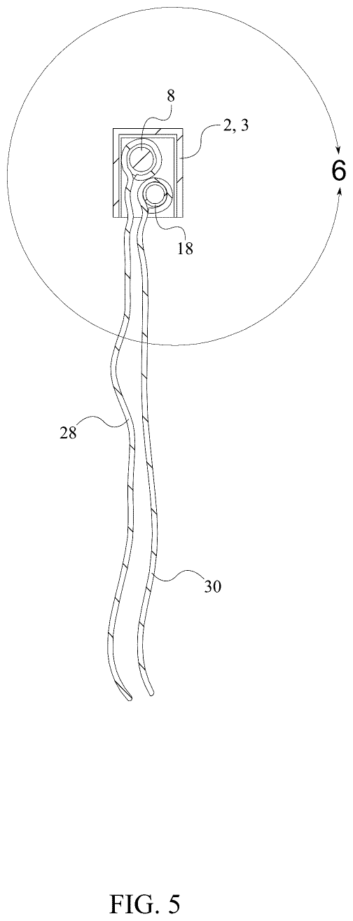

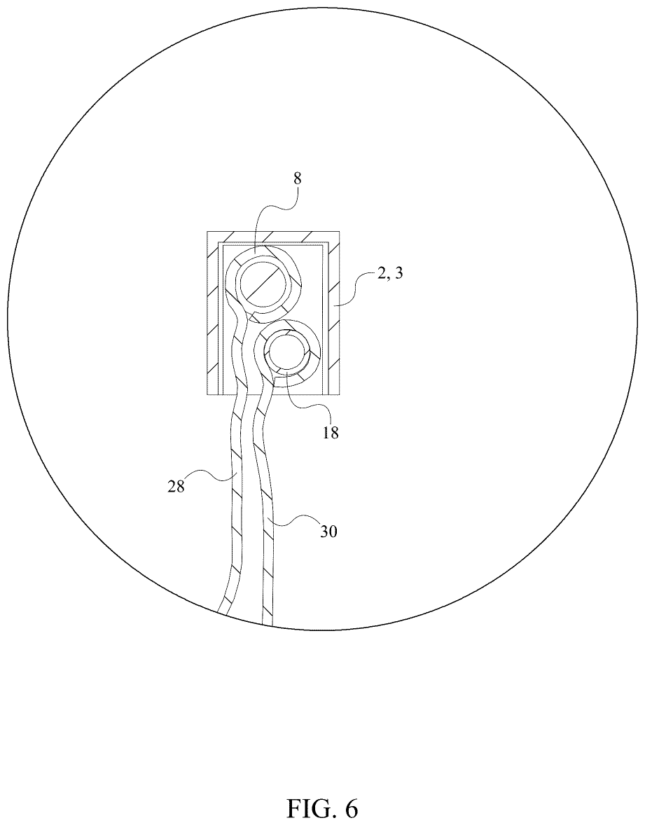

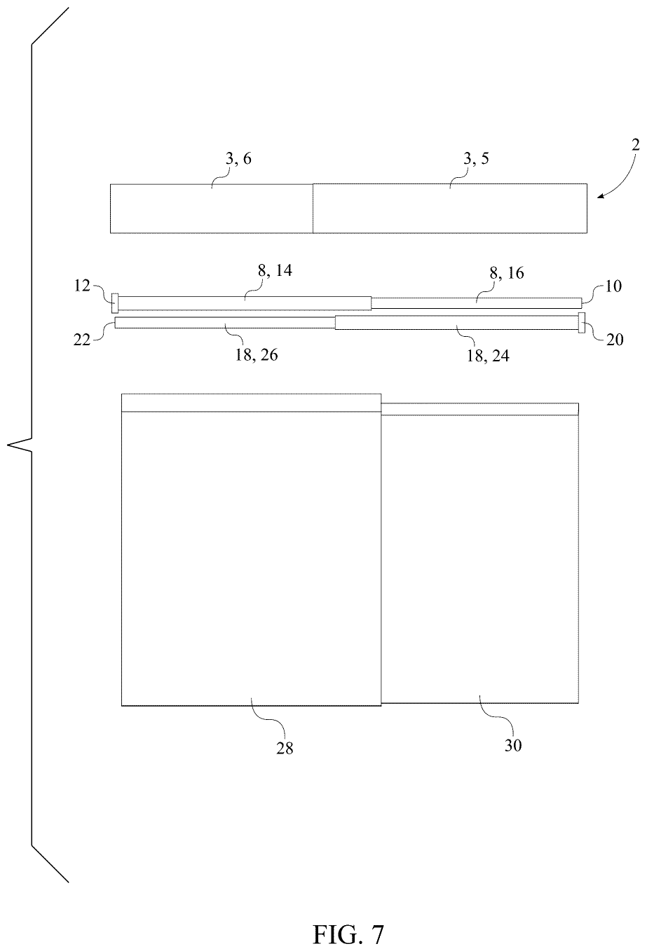

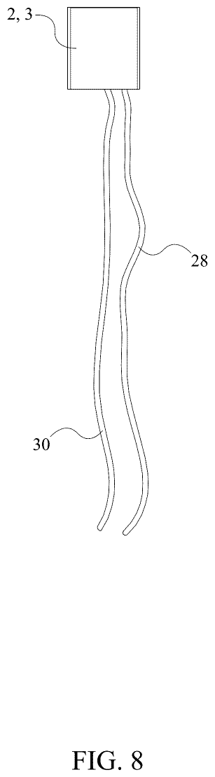

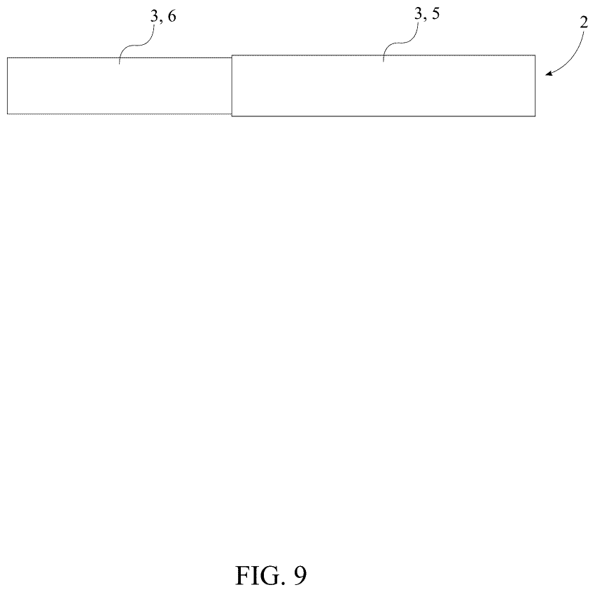

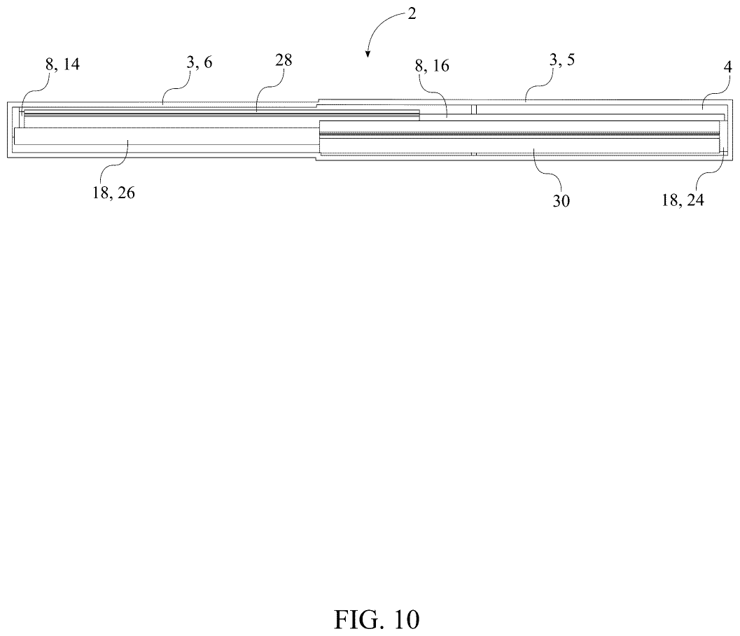

As can been seen in FIGS. 1 through 12, the proximal telescopic rod 8 may further comprise a proximal rod-receiving portion 14 and a proximal rod-insertable portion 16. The proximal rod-receiving portion 14 is a larger-diameter tubular member, while the proximal rod-insertable portion 16 is a smaller-diameter elongated member. The proximal rod-receiving portion 14 is longer than the proximal rod-insertable portion 16, and the proximal rod-insertable portion 16 is slidably engaged into the proximal rod-receiving portion 14, which allows a minimum length of the proximal telescopic rod 8 to be defined by a fixed length of the proximal rod-receiving portion 14. Consequently, a top edge of the proximal window covering 28 is exclusively connected along the proximal rod-receiving portion 14 so that lengthening or shortening the proximal telescopic rod 8 does not mechanically interfere with the proximal window covering 28. The fixed length of the proximal rod-receiving portion 14 is also greater than half of a maximum length of the proximal telescopic rod 8, which allows the proximal window covering 28 and the distal window covering 30 to overlap each other.

Similarly, the distal telescopic rod 18 may further comprise a distal rod-receiving portion 24 and a distal rod-insertable portion 26. The distal rod-receiving portion 24 is a larger-diameter tubular member, while the distal rod-insertable portion 26 is a smaller-diameter elongated member. The distal rod-receiving portion 24 is longer than the distal rod-insertable portion 26, and the distal rod-insertable portion 26 is slidably engaged into the distal rod-receiving portion 24, which allows a minimum length of the distal telescopic rod 18 to be defined by a fixed length of the distal rod-receiving portion 24. Consequently, a top edge of the distal window covering 30 is exclusively connected along the distal rod-receiving portion 24 so that lengthening or shortening the distal telescopic rod 18 does not mechanically interfere with the distal window covering 30. The fixed length of the distal rod-receiving portion 24 is also greater than half of a maximum length of the distal telescopic rod 18, which further allows the proximal window covering 28 and the distal window covering 30 to overlap each other.

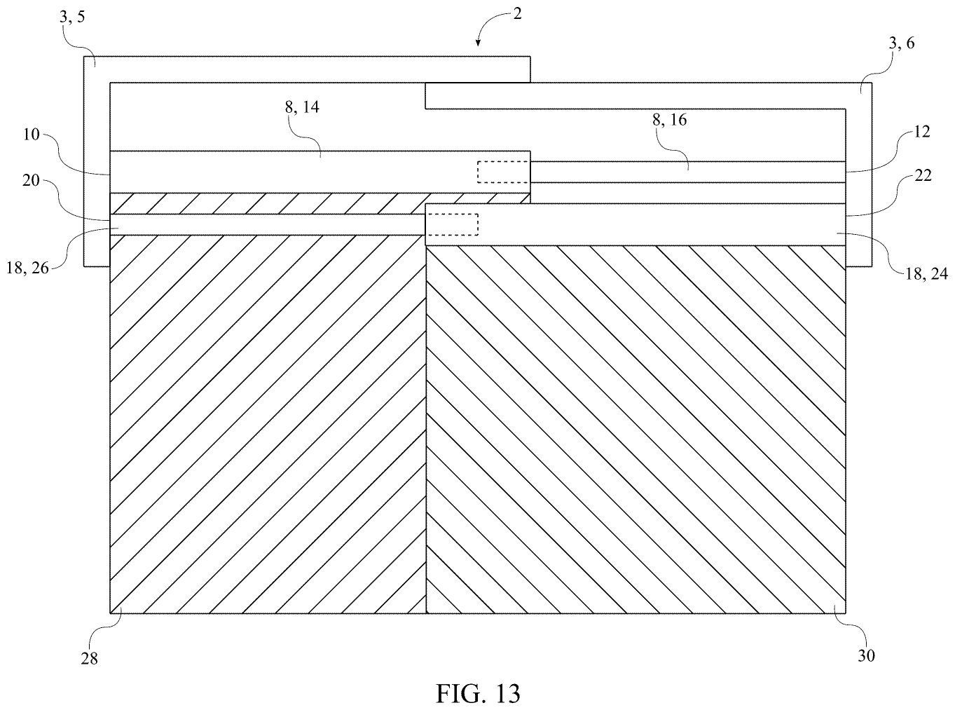

In one embodiment of the present invention shown in FIG. 13, the proximal rod-receiving portion 14 is positioned coincident with the first proximal rod end 10, and the distal rod-receiving portion 24 is positioned coincident with the second distal rod end 22, which allows the proximal window covering 28 to be positioned adjacent to the first body portion 5 and allows the distal window covering 30 to be positioned adjacent to the second body portion 6. Also in this embodiment, the proximal rod-insertable portion 16 is positioned coincident with the second proximal rod end 12, and the distal rod-insertable portion 26 is positioned coincident with the first distal rod end 20. Thus, the first proximal rod end 10 may be rotatably connected within the first body portion 5, and the second proximal rod end 12 may be torsionally connected within the second body portion 6, which allows the proximal rod-receiving portion 14 to act as a spool to roll up or down the proximal window covering 28. Further, the second distal rod end 22 may be rotatably connected within the second body portion 6, and the first distal rod end 20 may be torsionally connected within the first body portion 5, which allows the distal rod-receiving portion 24 to act as a spool to roll up or down the distal window covering 30.

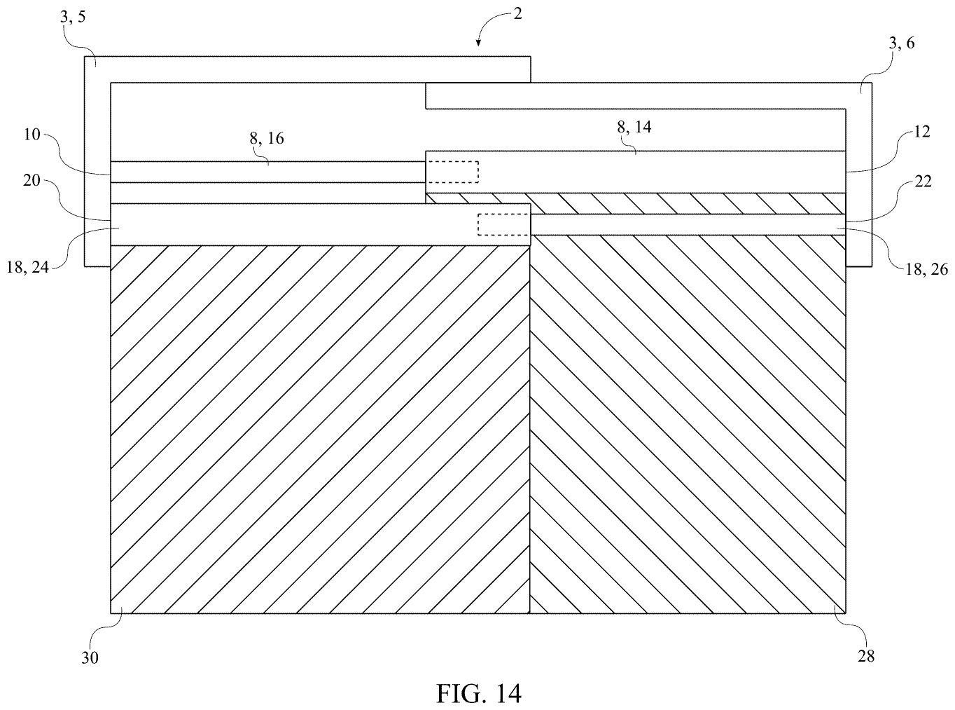

In an alternate embodiment of the present invention shown in FIG. 14, the proximal rod-receiving portion 14 is positioned coincident with the second proximal rod end 12, and the distal rod-receiving portion 24 is positioned coincident with the first distal rod end 20, which allows the proximal window covering 28 to be positioned adjacent to the second body portion 6 and allows the distal window covering 30 to be positioned adjacent to the first body portion 5. Also in this embodiment, the proximal rod-insertable portion 16 is positioned coincident with the first proximal rod end 10, and the distal rod-insertable portion 26 is positioned coincident with the second distal rod end 22. Thus, the second proximal rod end 12 may be rotatably connected within the second body portion 6, and the first proximal rod end 10 may be torsionally connected within the first body portion 5, which allows the proximal rod-receiving portion 14 to act as a spool to roll up or down the proximal window covering 28. Further, the first distal rod end 20 may be rotatably connected within the first body portion 5, and the second distal rod end 22 may be torsionally connected within the second body portion 6, which allows the distal rod-receiving portion 24 to act as a spool to roll up or down the distal window covering 30.

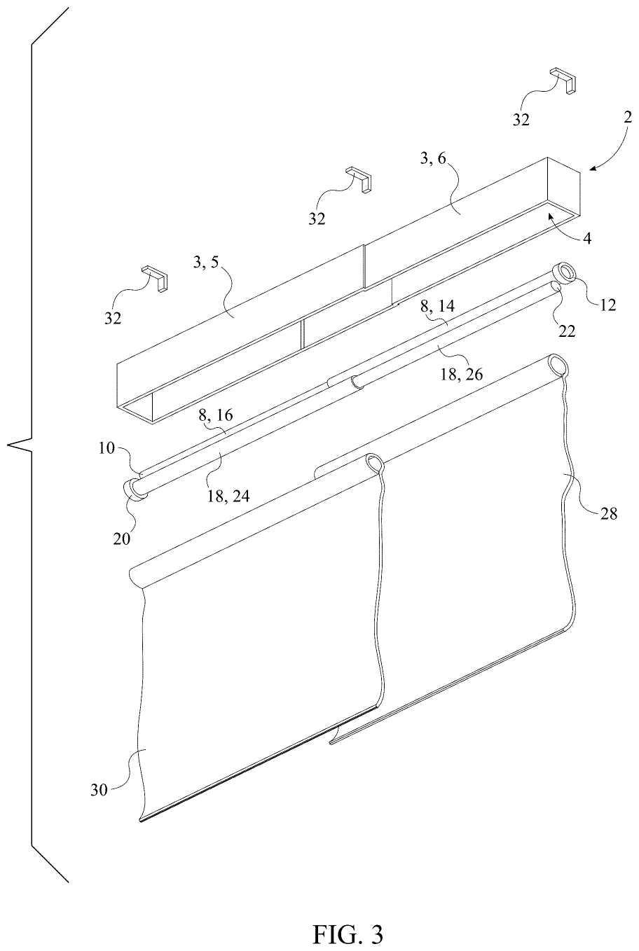

As can be seen in FIG. 3, the present invention may further comprise a plurality of mounting fasteners 32, which are used to physically secure the present invention within a window or door frame. Thus, the plurality of mounting fasteners 32 needs to be positioned about the mountable headrail 2 and to be externally connected to the mountable headrail 2 so that the plurality of mounting fasteners 32 is able to evenly support and secure the mountable headrail 2 within a window or door frame.

### Supplemental Description

In reference to FIG. 1 through FIG. 12, the present invention is an adjustable mounting apparatus with blinds for covering windows and/or doors.

The following description is in reference to FIG. 1 through FIG. 12. According to a preferred embodiment, the present invention comprises a headrail, a plurality of rods, a plurality of shades, and a plurality of fasteners. It is an aim of the present invention to provide an adjustable length to the headrail and the plurality of rods. In the preferred embodiment, the headrail is a rectangular structure that may be mounted within walls, window frames, door frames, or ceilings. Further, the headrail houses the plurality of rods in a concealed fashion within a cavity of the headrail. To accomplish length adjustability, the headrail comprises a first panel and a second panel wherein, a first terminal end of the second panel is slidably integrated within a second terminal end of the first panel. In other words, the first panel is slidably engaged with the second panel. This is so that the length of the headrail may be adjusted by sliding the second panel into the first panel to achieve a smaller length, or by sliding out the second panel from within the first panel to achieve a bigger length. As seen in FIG. 1 through FIG. 3, the headrail is a box-like structure with the cavity extending from a bottom surface of the main box-like structure. In other words, the cavity extends from a first surface of the headrail towards a second surface, wherein the first surface is positioned opposite to the second surface across the headrail. However, the headrail may comprise any other size, material, shape, components, arrangement of components, etc. that are known to one of ordinary skill in the art, as long as the intents of the present invention are not altered. The length of the shade is adjusted as per how many turns the rod will make and they can open and close independently or simultaneously.

According to the preferred embodiment, the plurality of rods comprises a first rod and a second rod that are laterally mounted within the cavity of the headrail. The plurality of rods is telescopic in nature. In other words, the ability to extend and retract between two interconnected pieces enables the plurality of rods to change their lengths depending on the width requirement of the mounting surface. More specifically, each of the plurality of rods has a first piece that is slidably mounted within a second piece and terminal ends of the first piece and the second piece are attached to the lateral sidewalls of the headrail. Thus, when the headrail is extended or contracted according to the width requirement of the mounting area, the plurality of rods will extend or contract accordingly as well. The plurality of rods is used to hang the plurality of shades from. As seen from FIG. 1 through FIG. 12, the plurality of rods is cylindrical in shape and the plurality of shades comprises fabric curtains, wherein the plurality of rods is threaded through a loop at the terminal ends of the plurality of shades. However, the plurality of rods and the plurality of shades may comprise any other shape, material, size, components, arrangement of components, etc. that are known to one of ordinary skill in the art, as long as the objectives of the present invention are fulfilled. Examples of rod materials include, but are not limited to wood, steel, aluminum, metal, hard plastic, etc. and examples of cross-sectional shapes of rods include but are not limited to, square, hexagon, rectangle, oval, etc. Examples of plurality of shades include but are not limited to roller blind type materials, pleated type fabrics, organic fabrics, etc. Similarly, the process of opening and closing the plurality of shades may comprise any technology, that is known to one of ordinary skill in the art (both manual and motorized), as long as the intents of the present invention are not altered.

According to the preferred embodiment, the first rod is positioned laterally offset from the second rod. This is so that a first shade from the plurality of shades may be hung from the first rod and a second shade from the plurality of shades may be hung from the second rod, such that lateral motion of each of the plurality of shades are not hindered by each other. Thus, based on the width of each of the plurality of shades, one shade may transpose over the other such that there is no gap between the plurality of shades along the central region. In other words, the position of the plurality of shades may be adjusted along the width of the window's dimensions by sliding the shades in and out according to luminosity needs.

In order to attach the headrail to the external surfaces such as frames, walls, and/or ceiling, as well as to mount the plurality of rods within the headrail, the plurality of fasteners is used. Preferably, a first set of fasteners from the plurality of fasteners are mounting brackets. The first set of fasteners may be mounted along the length and width of the headrail at different positions. The first set of fasteners enables the headrail to be mounted to any external surface that the user prefers. Further, a second set of fasteners from the plurality of fasteners may be used to mount the plurality of rods within the headrail. The second set of fasteners may comprise end caps, screws/nuts, and/or snap fasteners. However, it should be noted that the plurality of fasteners may comprise any size, shape, fastening mechanism, components, arrangement of components, etc. that are known to one of ordinary skill in the art, as long as the intents of the present invention are not altered.

According to the preferred embodiment, the present invention may be pre-assembled and made available to users as an assembled package such that users can easily install the entire mounting assembly easily without professional help. To that end, the plurality of rods may be pre-mounted within the headrail and the plurality of shades pre-attached to the plurality of rods. Thus, a user can choose the product based on the range of width dimensions that the package offers (for example 80 cm-150 cm) and the color and material of the shade fabric. Further, the first set of fasteners may be provided within the package, which the user may use to attach the headrail to the preferred surfaces. It is an objective of the present invention to enable extendibility along approximately 80% of the length of each of the plurality of rods, such that the one single package may be adaptable to a range of mounting surfaces/windows/doors.

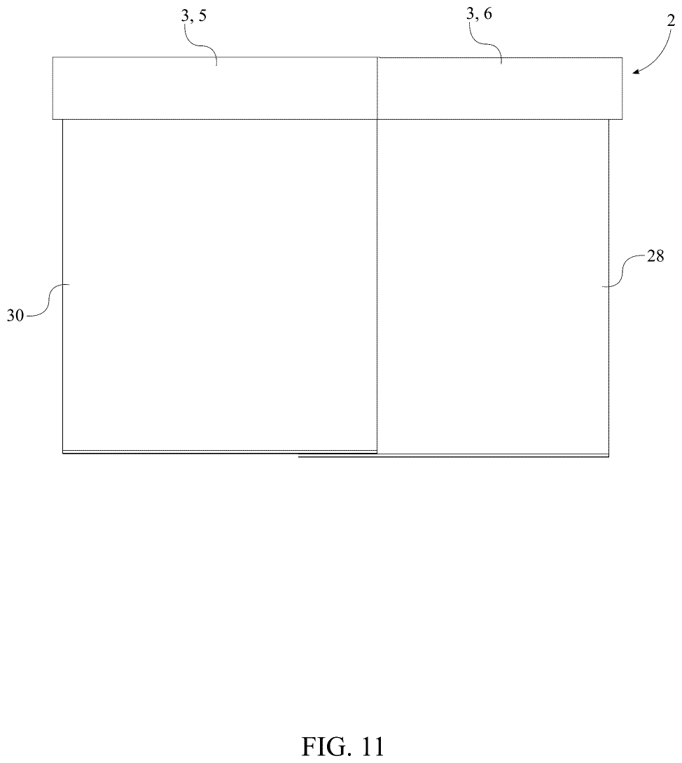

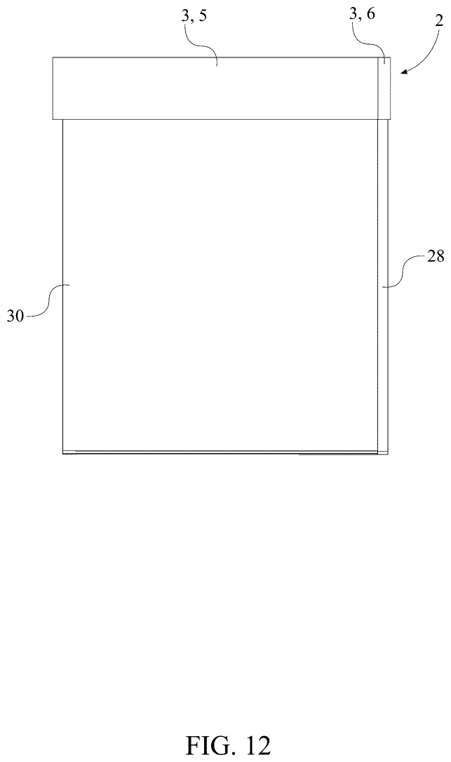

In reference to FIG. 11, the headrail and the plurality of rods are pulled out into an extended configuration to provide shade along a wider window. In reference to FIG. 12, the headrail and the plurality of rods are pushed into a retracted configuration, such that the same mounting assembly may be used for covering a smaller width window. As can be seen in FIG. 12, the plurality of shades may be left in a planar manner without any crunching or pleating, thereby providing aesthetic appeal. Thus, the present invention is a user-friendly, cost-effective, and adaptable invention that may be used for providing shade along a wide range of windows and doors surfaces.

Although the invention has been explained in relation to its preferred embodiment, it is to be understood that many other possible modifications and variations can be made without departing from the spirit and scope of the invention as hereinafter claimed.

What is claimed is:

1. An extendable mounting apparatus for a window covering comprising:
a mountable headrail;
a proximal telescopic rod;
a distal telescopic rod;
a proximal window covering;
a distal window covering;
the mountable headrail comprising a telescopic rail body and an elongated cavity;
the proximal telescopic rod comprising a first proximal rod end and a second proximal rod end;
the distal telescopic rod comprising a first distal rod end and a second distal rod end;
the telescopic rail body comprising a first body portion and a second body portion;
the first body portion and the second body portion being slidably connected to each other;
the elongated cavity laterally traversing into the telescopic rail body;
the proximal telescopic rod and the distal telescopic rod being positioned within the elongated cavity;
the proximal telescopic rod and the distal telescopic rod being positioned parallel and offset to each other;
the first proximal rod end and the first distal rod end being connected within the first body portion;
the second proximal rod end and the second distal rod end being connected within the second body portion;
the proximal window covering and the distal window covering traversing into the elongated cavity;
the proximal window covering being hung from the proximal telescopic rod the distal window covering being hung from the distal telescopic rod; and
the proximal window covering and the distal window covering overlapping each other.

2. The extendable mounting apparatus for a window covering as claimed in claim 1 comprising:
the proximal telescopic rod further comprising a proximal rod-receiving portion and a proximal rod-insertable portion;
the proximal rod-receiving portion being longer than the proximal rod-insertable portion;
the proximal rod-insertable portion being slidably engaged into the proximal rod-receiving portion;
a top edge of the proximal window covering being exclusively connected along the proximal rod-receiving portion; and
a fixed length of the proximal rod-receiving portion being greater than half of a maximum length of the proximal telescopic rod.

3. The extendable mounting apparatus for a window covering as claimed in claim 1 comprising:
the distal telescopic rod further comprising a distal rod-receiving portion and a distal rod-insertable portion;
the distal rod-receiving portion being longer than the distal rod-insertable portion;
the distal rod-insertable portion being slidably engaged into the distal rod-receiving portion;
a top edge of the distal window covering being exclusively connected along the distal rod-receiving portion; and
a fixed length of the distal rod-receiving portion being greater than half of a maximum length of the distal telescopic rod.

4. The extendable mounting apparatus for a window covering as claimed in claim 1 comprising:
a proximal rod-receiving portion of the proximal telescopic rod being positioned coincident with the first proximal rod end; and
a distal rod-receiving portion of the distal telescopic rod being positioned coincident with the second distal rod end.

5. The extendable mounting apparatus for a window covering as claimed in claim 4 comprising:
a proximal rod-insertable portion of the proximal telescopic rod being positioned coincident with the second proximal rod end;
the first proximal rod end being rotatably connected within the first body portion; and
the second proximal rod end being torsionally connected within the second body portion.

6. The extendable mounting apparatus for a window covering as claimed in claim 4 comprising:
a distal rod-insertable portion of the distal telescopic rod being positioned coincident with the first distal rod end;
the second distal rod end being rotatably connected within the second body portion; and
the first distal rod end being torsionally connected within the first body portion.

7. The extendable mounting apparatus for a window covering as claimed in claim 1 comprising:
a proximal rod-receiving portion of the proximal telescopic rod being positioned coincident with the second proximal rod end; and
a distal rod-receiving portion of the distal telescopic rod being positioned coincident with the first distal rod end.

8. The extendable mounting apparatus for a window covering as claimed in claim 7 comprising:
a proximal rod-insertable portion of the proximal telescopic rod being positioned coincident with the first proximal rod end;
the second proximal rod end being rotatably connected within the second body portion; and
the first proximal rod end being torsionally connected within the first body portion.

9. The extendable mounting apparatus for a window covering as claimed in claim 7 comprising:
a distal rod-insertable portion of the distal telescopic rod being positioned coincident with the second distal rod end;
the first distal rod end being rotatably connected within the first body portion; and
the second distal rod end being torsionally connected within the second body portion.

10. The extendable mounting apparatus for a window covering as claimed in claim 1 comprising:
a plurality of mounting fasteners;
the plurality of mounting fasteners being positioned about the mountable headrail; and
the plurality of mounting fasteners being externally connected to the mountable headrail.

11. An extendable mounting apparatus for a window covering comprising:
a mountable headrail;
a proximal telescopic rod;
a distal telescopic rod;
a proximal window covering;
a distal window covering;
a plurality of mounting fasteners;
the mountable headrail comprising a telescopic rail body and an elongated cavity;
the proximal telescopic rod comprising a first proximal rod end and a second proximal rod end;
the distal telescopic rod comprising a first distal rod end and a second distal rod end;
the telescopic rail body comprising a first body portion and a second body portion;
the first body portion and the second body portion being slidably connected to each other;
the elongated cavity laterally traversing into the telescopic rail body;
the proximal telescopic rod and the distal telescopic rod being positioned within the elongated cavity;
the proximal telescopic rod and the distal telescopic rod being positioned parallel and offset to each other;
the first proximal rod end and the first distal rod end being connected within the first body portion;
the second proximal rod end and the second distal rod end being connected within the second body portion;
the proximal window covering and the distal window covering traversing into the elongated cavity;
the proximal window covering being hung from the proximal telescopic rod;
the distal window covering being hung from the distal telescopic rod;
the proximal window covering and the distal window covering overlapping each other;
the plurality of mounting fasteners being positioned about the mountable headrail; and
the plurality of mounting fasteners being externally connected to the mountable headrail.

12. The extendable mounting apparatus for a window covering as claimed in claim 11 comprising:
the proximal telescopic rod further comprising a proximal rod-receiving portion and a proximal rod-insertable portion;
the proximal rod-receiving portion being longer than the proximal rod-insertable portion;
the proximal rod-insertable portion being slidably engaged into the proximal rod-receiving portion;
a top edge of the proximal window covering being exclusively connected along the proximal rod-receiving portion; and
a fixed length of the proximal rod-receiving portion being greater than half of a maximum length of the proximal telescopic rod.

13. The extendable mounting apparatus for a window covering as claimed in claim 11 comprising:
the distal telescopic rod further comprising a distal rod-receiving portion and a distal rod-insertable portion;
the distal rod-receiving portion being longer than the distal rod-insertable portion;
the distal rod-insertable portion being slidably engaged into the distal rod-receiving portion;
a top edge of the distal window covering being exclusively connected along the distal rod-receiving portion; and
a fixed length of the distal rod-receiving portion being greater than half of a maximum length of the distal telescopic rod.

14. The extendable mounting apparatus for a window covering as claimed in claim 11 comprising:
a proximal rod-receiving portion of the proximal telescopic rod being positioned coincident with the first proximal rod end; and
a distal rod-receiving portion of the distal telescopic rod being positioned coincident with the second distal rod end.

15. The extendable mounting apparatus for a window covering as claimed in claim 14 comprising:
a proximal rod-insertable portion of the proximal telescopic rod being positioned coincident with the second proximal rod end;
the first proximal rod end being rotatably connected within the first body portion; and
the second proximal rod end being torsionally connected within the second body portion.

16. The extendable mounting apparatus for a window covering as claimed in claim 14 comprising:
a distal rod-insertable portion of the distal telescopic rod being positioned coincident with the first distal rod end;
the second distal rod end being rotatably connected within the second body portion; and
the first distal rod end being torsionally connected within the first body portion.

17. The extendable mounting apparatus for a window covering as claimed in claim 11 comprising:
a proximal rod-receiving portion of the proximal telescopic rod being positioned coincident with the second proximal rod end; and
a distal rod-receiving portion of the distal telescopic rod being positioned coincident with the first distal rod end.

18. The extendable mounting apparatus for a window covering as claimed in claim 17 comprising:
a proximal rod-insertable portion of the proximal telescopic rod being positioned coincident with the first proximal rod end;
the second proximal rod end being rotatably connected within the second body portion; and
the first proximal rod end being torsionally connected within the first body portion.

19. The extendable mounting apparatus for a window covering as claimed in claim 17 comprising:
a distal rod-insertable portion of the distal telescopic rod being positioned coincident with the second distal rod end;
the first distal rod end being rotatably connected within the first body portion; and
the second distal rod end being torsionally connected within the second body portion.
